(19) United States
(12) Patent Application Publication
(10) Pub. No.: US 2015/0250198 A1
(43) Pub. Date: Sep. 10, 2015

(54) PROCESS OF ROASTING COFFEE BEANS AND OTHER EDIBLE SEEDS

(71) Applicants: Jan Piskorz, Waterloo (CA); Piotr Majerski, Waterloo (CA)

(72) Inventors: Jan Piskorz, Waterloo (CA); Piotr Majerski, Waterloo (CA)

(21) Appl. No.: 14/203,111

(22) Filed: Mar. 10, 2014

(51) Int. Cl. A23F 5/04

(52) U.S. Cl. CPC A23F 5/04

(57) ABSTRACT

A process of roasting green coffee beans and other edible seeds that enhances the rate of browning and the aromas and flavors of the roasted product, particularly a coffee beverage made from roasted coffee beans. The process comprises treating the green coffee beans or other edible seeds with a solution of Hodge carbonyls and then heating the treated coffee beans or seeds at a temperature and for a duration sufficient to achieve a desired color or aroma to the coffee beans or seeds.

### FIELD OF THE INVENTION

The present invention relates to processes for roasting seeds such as nuts, kernels, beans and grains, and particularly to a new method of roasting coffee beans involving the treating of the green coffee beans before the subsequent roasting processing. Such treatment enhances the roasting process and provides commercial roasters with an additional tool to impart new aromas and flavors, and thereby to diversify their roasted products.

### BACKGROUND

Coffee beverages are widely consumed throughout the world and consumer tastes have diversified with regard to coffee flavor and aroma. As part of the process of producing a coffee beverage, green coffee beans are extracted from the coffee cherries (the fruit of the coffee plant) by removal of the husk and pulp portions. The green coffee beans are then roasted in a heat treatment process to achieve a dark brown to black color, thereby producing the components responsible for the tastes and aromas that are characteristic of coffee.

Conventional methods of creating coffee bean roasts rely on varying the heating temperature, heating duration, and other heating parameters during the roasting process to create different degrees of roasting to provide diverse coffee flavors and aromas. Generally, there are four recognized color categories of coffee roasts: light, medium, medium-dark, and dark; the latter roast includes French roast, Italian roast, and Espresso roast, among others. Although roasted coffee beans with differing degrees of tartness, bitterness, and so on, can be obtained at each of these levels, the production of new coffee aromas and flavors is limited.

It is recognized in the food sciences that complex chemical reactions occur during heating processes on foods, which are responsible for the final overall aroma, flavor, color, taste and texture of the food. While the qualitative result of the heating processes on foods is readily apparent, the underlying chemical reactions responsible for them have not been understood until 1912, when Louis-Camille Maillard published his efforts trying to explain what happens when amino acids react with sugars at elevated temperatures. But it was J. E. Hodge in 1953 who described a mechanism of the “Maillard reaction” in his article “Dehydrated Foods, Chemistry of Browning Reactions in Model Systems”, Journal of Agricultural and Food Chemistry, 1, (15), pp. 928-943, which is incorporated herein by reference. Hodge's article described the series of reactions, often referred to as the “Hodge Scheme”, which remains to this day the generally accepted Maillard reaction pathway. Hodge carbonyls, as defined here, are sugar-derived carbonyls from the Hodge Scheme. Especially of interest are carbonyls, dicarbonyls, hydroxycarbonyls such as hydroxyacetaldehyde, glyoxal, pyruvaldehyde, acetol, glyceraldehyde, formaldehyde, acetaldehyde, furfurals and acetals. In human physiology, Hodge carbonyls are considered as intermediate metabolites or as products of metabolism. As accepted today, the Maillard reaction is defined as a form of nonenzymatic browning, where the reactive carbonyl groups of the sugar carbonyls react with amino group of the amino acids in proteins to form a complex mixture of poorly characterized molecules responsible for a range of aromas, colors and flavors. Typically in the process, hundreds of different volatile aroma or flavor molecules are created. Melanoidins, nitrogenous co-polymers, which are responsible for brown coloration of foods, are also formed in later stages of the Maillard reaction. Melanoidin pigments are responsible for different shades of browning in our foods. Generally, each type of food has a very distinctive set of flavor compounds and a different set of melanoidins that are formed during the Maillard reaction. In case of coffee roasts, the volatile fraction is extremely complex, reportedly consisting of more than 700 compounds. See for example Maarse H., Visscher Calif., (1989), Volatile Compounds in Food, Vol. II. TNO-CIVO Food Analysis Institute, Zeist, NL, incorporated herein by reference.

Conventional methods of creating coffee bean roasts, in which various types of roasted coffee beans with different degrees of roasting are produced by changing the heating temperature, heating duration, and the like during the roasting process, are generally employed as a method for creating diverse coffee flavors and aromas in order to respond to such consumer needs. It would be advantageous if other tools were available to roasters by which to create enhanced flavors and aromas in the roasted products, and thereby increase the diversity in their product offerings.

### SUMMARY

Described are methods of treating edible seeds, nuts, kernels and grains with a solution of comprising Hodge carbonyls prior to a roasting step to achieve an enhanced flavor in the end product and a desired degree of browning in a shorter period of time or a lower temperature, or both, than is achieved by a method of roasting on its own. In particular, described is a process of treating green (unroasted) coffee beans with a solution comprising Hodge carbonyls prior to a roasting step to achieve a desired degree of browning of the beans in a shorter period of time or a lower temperature, or both, than is achieved by roasting alone, and which roasted beans produce a coffee beverage having enhanced flavor characteristics.

In one aspect, a process for roasting green coffee beans is provided comprising the steps of treating the green coffee beans with a solution of Hodge carbonyls, and heating the treated coffee beans at a temperature and for a duration sufficient to achieve a desired color or aroma to the coffee beans. In some embodiments, the amount of Hodge carbonyls used may comprise at least 0.46% by weight of the treated coffee beans excluding the weight of water in the beans. The amount of Hodge carbonyls used may comprise at least 0.64% by weight of the treated coffee beans excluding the weight of water in the beans. The amount of Hodge carbonyls used may comprise at least 1.2% by weight of the treated coffee beans excluding the weight of water in the beans. In some embodiments, the amount of Hodge carbonyls used may comprise at least 0.46% by weight of the treated coffee beans excluding the weight of water in the beans but no more than about 8%. The Hodge carbonyls may consists of one or more of hydroxyacetaldehyde, glyoxal, pyruvaldehyde, acetol and formaldehyde, or the Hodge carbonyls may consist of hydroxyacetaldehyde. In some embodiments, a step of drying the treated coffee beans is provided before the step of heating. In some embodiments, the solution of Hodge carbonyls is a natural wood smoke condensate, which may be produced by pyrolysis of biomass.

In another aspect, a process for roasting raw edible seeds is provided comprising the steps of treating the raw seeds with a solution of Hodge carbonyls, and heating the treated seeds at a temperature and for a duration sufficient to achieve a desired color or aroma to the seeds. In some embodiments, the amount of Hodge carbonyls used may comprise at least 0.46% by weight of the treated coffee beans excluding the weight of water in the beans. The amount of Hodge carbonyls used may comprise at least 0.64 by weight of the treated seeds excluding the weight of water in the seeds. The amount of Hodge carbonyls used may comprise at least 1.2% by weight of the treated seeds excluding the weight of water in the seeds. In some embodiments, the amount of Hodge carbonyls used may comprise at least 0.46% by weight of the treated seeds excluding the weight of water in the seeds, but no more than about 8%. The Hodge carbonyls may consists of one or more of hydroxyacetaldehyde, glyoxal, pyruvaldehyde, acetol and formaldehyde, or the Hodge carbonyls may consist of hydroxyacetaldehyde. In some embodiments, a step of drying the treated seeds is provided before the step of heating. In some embodiments, the solution of Hodge carbonyls is a natural wood smoke condensate, which may be produced by pyrolysis of biomass.

### DETAILED DESCRIPTION

Processes of roasting green coffee beans and other edible seeds are described that enhance the rate of browning and the aromas and flavors of the roasted product, particularly that of a coffee beverage made from roasted coffee beans. In one aspect, green (unroasted) coffee beans are treated with a solution comprising Hodge carbonyls prior to a roasting step to achieve a desired degree of browning of the beans in a shorter period of time or a lower temperature, or both, than is achieved by roasting alone, and which roasted beans produce a coffee beverage having enhanced flavor characteristics. The lower temperature, shorter heating time, or both, provided by the present invention in achieving a desired degree of browning means that the roasted coffee beans will have a higher amounts of chlorogenic acids and N-methylpyridinium cations. Chlorogenic acids (CGA) are important mediators of the antioxidative activity. However, during roasting of coffee beans, CGA are increasingly degraded with time during roasting activity, whereby bitter tasting caffeic acid, quinic acid, as hydroxybenzenes are generated. In general, a darker roast that requires a high severity roasting conditions (higher temperatures and/or longer roasting times) correlates with a lower concentration of CGA. Thus, if high concentrations of CGA are desired in roasted coffee beans, then the severities of roasting should be kept to “light” level. But a light roast will result in light flavor and aroma characteristic. However, by employing the process of the present invention, a darker coffee roast may be achieved under less severe roasting conditions, thereby producing a dark roast with higher CGA than would be achieved by conventional roasting. And the enhanced aroma and flavor of the end product provides coffee roasters with an additional tool to impart new aromas and flavors to their roasted coffee product, and thereby to diversify their product offerings.

The present invention involves treating the unroasted seeds, nuts, kernels and grains, and in particular green coffee beans, with a solution of Hodge carbonyls. Hodge carbonyls as referred to herein consist of one or more of hydroxyacetaldehyde, glyoxal, pyruvaldehyde, acetol, glyceraldehyde, formaldehyde, acetaldehyde, furfurals and acetals. Methods of producing Hodge carbonyl compounds are known in the art. For example, dextrose-derived solutions containing Hodge carbonyls in water are commercially available under trademarks such as for example, FOREST GOLD™′ SCANGOLD™, AURIC™, and GRAYSON GOLD™. Powder equivalents of these products are also commercially available. Such products are used in food industry as browning agents, flavor precursors, food ingredients, or processing aids. Hodge carbonyl compounds may also be produced by pyrolysis of biomass, such as cellulose and hemicelluloses (holocellulose), typically at temperatures above 480° C., to convert the biomass to carbohydrate fragments like hydroxyacetaldehyde, glyoxal, methylglyoxal, acetol, formaldehyde, such as described in U.S. Pat. No. 8,436,120. Also known are Hodge carbonyls in watery solutions of many marketable wood derived natural smoke condensates. Examples of wood derived natural smoke condensates include ADVANTAGE™, ZESTI™, BIOSMOKE™, ENVIRO™, CHARSOL™ SMOKEZ™, TRADISMOKE™, FUMOKOMP™, and PROFAGUS™. A detailed analysis of a variety of wood smokes condensates is found in “Proceedings of the Fourth Biomass Conference of the Americas”, Oakland, R. P. Overend, E. Chornet (Eds), Elsevier Science 1999, pp. 1153-1160, which is incorporated herein by reference. The food items that have been processed using the above solutions do not contain free Hodge carbonyls in the roasted (final-consumable) form. By themselves and in concentrated form, Hodge carbonyls are not edible. But as applied to foods, they act like short lifetime, true intermediates/precursors, augmenting those naturally forming through the Maillard reaction during heating, where sugars are thermally degraded. Sugar carbonyls do not survive cooking processing.

The treatment of the unroasted seeds, nuts, kernels and grains, and in particular green coffee beans, which are collectively referred to herein as the starting seed material for simplicity, with a solution of Hodge carbonyls may be by spraying the solution on the starting seed material, rinsing the starting seed material with the solution, or soaking the starting seed material in the solution for a period of time. The purpose of the treatment step is to infuse the starting seed material with the solution, hence although soaking is effective, it is not necessary that the starting seed material be kept in the solution for any period of time longer than is necessary to infuse the starting seed material. The present invention could be applied to any green coffee beans, from different sources, countries, locations, etc.

The examples that follow are intended to further illustrate, and not limit, embodiments in accordance with the methods disclosed herein.

### Example 1

Samples of green coffee beans, pumpkin seeds, and wheat grains, each weighing 20 g, were each treated with 30 ml of FOREST GOLD™ #925, which is a commercially available water based solution of Hodge carbonyls, to achieve a coating of the solution on the respective samples. As analyzed, the FOREST GOLD™ #925 solution contained the following in wt % of the solution.

| | |
|---|---|
| Hydroxyacetaldehyde | 25.0 |
| Glyoxal | 1.9 |
| Pyruvaldehyde | 1.5 |
| Formaldehyde | 4.0 |
| Levoglucosan | 0.5 |
| Acetol | 1.2 |
| Acetic acid | 0.2 |
| Furfurals | 0.2 |
| Water | ~63.5 |
| Total above | 98.0 |
| Total carbonyls | 33.8 |

The total carbonyls concentration in water was approximately 34 wt %. The samples were each dried at 60° C. in a draft oven for approximately 16 hours, upon which the green coffee beans exhibited a color change to orange/brown, the pumpkin seeds exhibited a color change to green-brown, and the wheat grains exhibited a color change to become more yellow. The observable color penetration was through the whole interior of the seed. While not wishing to be limited by theory, such reactive color development at 60° C. only suggest that initial Mailard like reactions occurred involving reactive precursors, and that some synthesis of melanoidin pigmentation already took place. The estimated uptake of Hodge carbonyls, on dry coffee beans basis—as indicated by the beans' weight gain—was ˜8 wt %.

### Example 2

Treated and dried coffee beans obtained as described in Example 1, orange/brown in color, were roasted in a muffle furnace at 240° C. br 10 minutes. The coffee beans became black and the aroma of roasted coffee was overwhelming and obvious. A sensory evaluation indicated that no malodor was created. For comparison, non-treated coffee beans were processed and roasted in the same way, but only light brown beans were obtained at the end of the roasting step—not black ones. The applied treatment of the coffee beans with the Hodge carbonyl solution clearly enhanced the roasting process, resulting in a much darker coffee bean roast than that attained by the untreated control sample.

### Example 3

A sample of green coffee beans (in this case Brazilian Invalsa) was treated with the commercially available solution containing Hodge carbonyls, described as “natural wood smoke condensate” SP-48, comprised of the following by wt % of the solution:

| | |
|---|---|
| Hydroxyacetaldehyde | 5.0 |
| Glyoxal | 1.5 |
| Pyruvaldehyde | 1.3 |
| Levoglucosan | 2.5 |
| Acetol | 1.5 |
| Acetic acid | 3.8 |
| Formaldehyde | ~1.0 |
| Furfurals | 0.2 |
| Phenols | ~1.5 |
| Water | ~70 |

The sugar carbonyls (such as hydroxyacetaldehyde, glyoxal, pyruvaldehyde, acetol, formaldehyde) total approximately 10 wt % of the solution. The coffee beans were then dried at 60° C. for approximately 16 hours, after whch the beans exhibited an orange/brown color indicating an initial progress of the Maillard reaction had occurred as suggested by the developed pigmentation.

### Example 4

In comparison to Example 3, green coffee beans were treated in a similar fashion with 5 wt % aqueous glucose solution. Upon drying at 60° C. the beans did not change their coloration to orange/brown, but rather remained a dirty-green in color. It is evident that glucose, also known commercially as dextrose, does not participate in color forming reactions at this temperature.

### Example 5

A household coffee bean roasting machine available under the brand Fresh Roast™, model SR-500, was used to carry out comparable roasts of green coffee bean samples as indicated in the table below. The green coffee beans that were used were a Columbia Santa Barbara Estate and the object was to achieve a “light” roast. The coffee bean samples were each roasted at a measured temperature in the roasting machine of 175° C. for 6 minutes. The results of the comparable roasts evaluated on the basis of color development are shown in the table below.

### Color Development

| | | | Hodge' carbonyls treated |
|---|---|---|---|
| | Raw | Glucose treated green | green beans with diluted |
| | green | beans, aqueous | Forest Gold comprising of |
| | beans | solution 5% | Hydroxyacetaldehyde 5 wt % |
| Color | Light | Brown, not uniform | Black, glossy, uniform |
| observable | brown | color | |

It was found that the green coffee beans that were treated with a solution of Hodge carbonyls developed roasting pigmentation much more quickly than raw untreated coffee beans. Hence the treatment of the green coffee beans resulted in an accelerated browning.

### Example 6

Samples of Cuban Altura Lavado green coffee beans were roasted in a Fresh Roast™ SR-500 roasting machine at a temperature of 175° C. for 9 minutes, with the objective of achieving a medium roast. Some of the samples were untreated green coffee beans, while other samples were treated with Hodge carbonyls solution, being diluted Forest Gold comprising of Hydroxyacetaldehyde 5 wt % (as in Example 5). A sensory evaluation of coffee beverages made espresso style from each of the roasted samples was performed in blind tastings. The coffee beverages made from the Hodge carbonyl treated roasted beans were selected as having preferable taste and aroma over the standard, non-treated roasted beans. This observation underlines the potential in creating new or enhanced coffee aromas by the present invention as a modulation in the coffee flavors was achieved thereby.

### Example 7

Samples of Cuban Altura Lavado green coffee beans that were treated with the natural smoke condensate solution as in Example 3 were roasted in a Fresh Roast™ SR-500 roasting machine at a temperature of 175° C. for 9 minutes to achieve a medium roast. Sensory evaluation of brewed coffee beverages made from such beans indicated a presence of new delicate smoky notes in the overall aroma profile. Therefore, the present invention not only enhances the development of pigmentation of the beans during roasting, but also it can imprint new aromas to the roasted beans.

### Example 8

In order to determine the effect of different treatment quantities of the Hodge carbonyls for coffee beans, the following samples were prepared:
1. Green beans+0.46 wt % Hodge carbonyls
2. Green beans+0.64 wt % Hodge carbonyls
3. Green beans+1.2 wt % Hodge carbonyls

The Hodge carbonyls concentration of each was determined. Weight percentages are given calculated on overall weight of treated beans. Water is excluded in the given percent values. The three samples were dried at 60° C. resulted in yellow-orange irregular color beans, though sample 3 showed a relatively darker shade of color than for sample 1. Roasting sample 3 in a Fresh Roast™ SR-500 coffee roaster at 175° C. resulted in beans of nice brown color after 3 minutes. If continued, after 10 minutes of roasting the beans were black. Accordingly, a dark level of roasting was achieved at much lower severity (i.e. lower temperature, shorter roasting time, or both) of processing than with prior art methods. For relative comparison, the typical commercial “dark roasting” conditions, as reported by the Tim Horton Co., are 12 minutes at 215° C. One can conclude that treatment of green coffee beans with Hodge carbonyls at quantities in the single digit percentage levels significantly boosted the roasted color development beyond what would be expected from non-treated beans. The accelerated browning of the treated beans is again evident. Increasing the amount of Hodge carbonyls beyond about 8 wt % (excluding water content in the beans) as discussed in Example 1 is not likely to produce any significant additional benefit in terms of roasted color development, enhanced flavor and aroma.

The above examples describe a drying step of the treated seed material prior to the roasting step. However, it will by readily apparent that a heating process of wet treated seed material, such as a roasting process, inherently results in an initial drying of the seed material. Hence, the treated seed material may be roasted directly after treatment with the Hodge carbonyl solution. One may prefer to use an intermediate drying step in circumstances where storage or transport of dry treated seed material is desired or required prior to the actual roasting process. For example, green coffee beans may be treated with a Hodge carbonyl solution, dried, packaged and then distributed to roasters as a dried product.

While this invention has been disclosed with reference to specific examples or embodiments, it is apparent that other variations may be devised by skilled in the art without departing from the scope of the invention as defined by the appended claims. The appended claims are intended to be construed to include all such embodiments and equivalent variations.

1. A process for roasting green coffee beans comprising the steps of:
a. treating the green coffee beans with a solution comprising Hodge carbonyls; and
b. heating the treated coffee beans at a temperature and for a duration sufficient to achieve a desired color or aroma to the coffee beans.

2. The process as claimed in claim 1 wherein the amount of Hodge carbonyls used comprises at least 0.46% by weight of the treated coffee beans excluding the weight of water in the beans.

3. The process as claimed in claim 1 wherein the amount of Hodge carbonyls used comprises at least 0.64% by weight of the treated coffee beans excluding the weight of water in the beans.

4. The process as claimed in claim 1 wherein the amount of Hodge carbonyls used comprises at least 1.2% by weight of the treated coffee beans excluding the weight of water in the beans.

5. The process as claimed in claim 1 wherein the amount of Hodge carbonyls used comprise at least 0.46% by weight of the treated coffee beans excluding the weight of water in the beans, but no more than about 8%.

6. The process as claimed in claim 1 wherein the Hodge carbonyls consists of one or more of hydroxyacetaldehyde, glyoxal, pyruvaldehyde, acetol and formaldehyde.

7. The process as claimed in claim 1 wherein the Hodge carbonyls consists of hydroxyacetaldehyde.

8. A process for roasting raw edible seeds comprising the steps of:
a. treating the raw seeds with a solution comprising Hodge carbonyls; and
b. heating the treated seeds at a temperature and for a duration sufficient to achieve a desired color or aroma to the seeds.

9. The process as claimed in claim 8 wherein the amount of Hodge carbonyls in the solution comprise at least 0.46% by weight of the treated seed excluding the weight of water in the seeds.

10. The process as claimed in claim 8 wherein the amount of Hodge carbonyls used comprise at least 0.46% by weight of the treated seeds excluding the weight of water in the seed, but no more than about 8%.

11. The process as claimed in claim 8 wherein the Hodge carbonyls consist of one or more of hydroxyacetaldehyde, glyoxal, pyruvaldehyde, acetol, and formaldehyde.

12. The process as claimed in claim 8 wherein the Hodge carbonyls consists of hydroxyacetaldehyde.

13. The process as claimed in claim 2 further comprising the intermediate step of drying the treated coffee beans before the step of heating.

14. The process as claimed in claim 2 wherein the solution of Hodge carbonyls is a natural wood smoke condensate.

15. The process as claimed in claim 14 wherein the natural wood smoke condensate is produced by pyrolysis of biomass.

16. The process as claimed in claim 8 further comprising the intermediate step of drying the treated seeds before the step of heating.
